(19) United States
(12) Patent Application Publication
(10) Pub. No.: US 2024/0053864 A1
(43) Pub. Date: Feb. 15, 2024

(54) SYSTEM AND METHOD FOR INTERACTING WITH COMPUTING DEVICE

(71) Applicant: SOCRATIC SCIENCES, Boise, ID (US)

(72) Inventors: Gregory B. STOCK, Boise, ID (US); Noah FALSTEIN, San Rafael, CA (US); Christine Janae LEONIAK, Portland, OR (US); Zachary David CHAMBERS HILL, New York, NY (US); Steven Fredrick ELLIOTT, Ann Arbor, MI (US); Margaret Eileen COLES, San Francisco, CA (US); Karl Niklas LILJA, Tokyo (JP)

(73) Assignee: SOCRATIC SCIENCES, Boise, ID (US)

(21) Appl. No.: 18/210,453

(22) Filed: Jun. 15, 2023

Related U.S. Application Data
(63) Continuation of application No. PCT/US2021/064271, filed on Dec. 20, 2021.
(60) Provisional application No. 63/127,547, filed on Dec. 18, 2020.

(51) Int. Cl. G06F 3/0482; G06F 3/0488; G06F 3/0485

(52) U.S. Cl. CPC G06F 3/0482; G06F 3/0488; G06F 3/0485; G06F 2203/04806

(57) ABSTRACT

An improved graphical user interface (GUI) for use with a computing device that arranges information/icons in a circular or loop-like fashion. The GUI includes a plurality of nodes arranged on a circular element. The GUI may display only a portion of the circular element and associated nodes and may permit the user to rotate the circular element to rotate the circular element to bring the nodes into the displayed area. The user may select a node to access the selected node and bring a new sub-circle associated with that node into view (in a sub-circle embedded within a circle arrangement).

### CROSS-REFERENCE TO RELATED APPLICATIONS

This application is a bypass continuation of International Application No. PCT/US2021/064271, filed Dec. 20, 2021, which claims priority to U.S. Provisional Patent Application No. 63/127,547 entitled “SYSTEM AND METHOD FOR INTERACTING WITH COMPUTING DEVICE” filed on Dec. 18, 2020. Each patent application referenced above is hereby incorporated by reference as if fully set forth herein in its entirety.

### FIELD

The present disclosure relates to an improved graphical user interface for use with a computing device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

People interact with computing devices (mobile phones, laptops, smart speakers or other smart devices, desktop computers, etc.) in many ways. Typically, a user clicks on, touches, or otherwise selects a folder, application, or other icon, which then opens the folder, launches the application, or otherwise operates on the icon. These icons are sometimes presented in a list or are presented and arranged in a visual organization. For example only, on a mobile phone, icons are arranged on various screens that users can switch between to access the various icons. While this type of arrangement may be familiar to a user, it is quite utilitarian and may not be the most efficient and/or elegant manner to present such information. It would be desirable to provide an improved system and computer-implemented method that permits a user to easily interact with a computing device, a website, or computer application in a useful and elegant manner.

### SUMMARY

In various embodiments of the present disclosure, a computer-implemented method for interacting with a computing device is disclosed. The method can include displaying, on a touchscreen display of a computing device having one or more processors, a graphical user interface (“GUI”). The GUI can include a looping structure, and a plurality of nodes arranged on the looping structure. The plurality of nodes can include at least one hidden node and at least one visible node. The method can further include receiving, at the computing device, a touch input from a user via the touchscreen display. The touch input can comprise a swiping gesture. In response to the touch input, the method can include rotating the looping structure, and automatically relocating at least one of the plurality of nodes such that a first hidden node becomes visible on the touchscreen display.

In some aspects, the looping structure can comprise a circular or oval shaped element.

In some aspects, the swiping gesture can comprise a touch and swipe on the touchscreen display.

In some aspects, the plurality of nodes can be are arranged on the looping structure such that each node of the plurality of nodes is arranged at a respective position on the looping structure, and wherein a hidden portion of the looping structure is not displayed on the touchscreen display such that the at least one hidden node corresponds to the hidden portion.

In some aspects, the method can further comprise receiving, at the computing device, a second touch input from the user via the touchscreen display. The second touch input can correspond to a selection of the at least one visible node. In response to the second touch input, the method can include transitioning the GUI to display a second looping structure associated with the selected at least one visible node, and a plurality of sub-nodes arranged on the second looping structure. The plurality of sub-nodes can include at least one hidden sub-node and at least one visible sub-node.

In some aspects, transitioning the GUI to display the second looping structure and the plurality of sub-nodes arranged on the second looping structure can comprise zooming into the looping structure.

In some aspects, the method can further comprise receiving, at the computing device, a third touch input from the user via the touchscreen display. The third input can correspond to an instruction to redisplay the looping structure. In response to the third touch input, the method can include transitioning the GUI to display the looping structure and the plurality of nodes arranged on the looping structure.

In some aspects, transitioning the GUI to display the looping structure and the plurality of nodes arranged on the looping structure can comprise zooming out of the second looping structure.

In some aspects, the method can further comprise, in response to the touch input, automatically relocating at least one of the plurality of nodes such that a first visible node becomes hidden or otherwise not shown on the touchscreen display.

In some aspects, the method can further comprise receiving, at the computing device, a pinning input from the user. The pinning input can be associated with a particular visible node and can correspond to an instruction to pin the particular visible node to be displayed on the looping structure such that the particular visible node is consistently displayed in the GUI until being unpinned.

In various embodiments of the present disclosure, a computing device is disclosed. The computing device can include one or more processors, a touchscreen display operably connected to the one or more processors, and a non-transitory computer-readable storage medium having a plurality of instructions stored thereon. When executed by the one or more processors, the plurality of instructions can cause the one or more processors to perform operations. The operations can include displaying, on the touchscreen display, a graphical user interface (“GUI”). The GUI can include a looping structure, and a plurality of nodes arranged on the looping structure. The plurality of nodes can include at least one hidden node and at least one visible node. The operations can further include receiving a touch input from a user via the touchscreen display. The touch input can comprise a swiping gesture. In response to the touch input, the operations can include rotating the looping structure, and automatically relocating at least one of the plurality of nodes such that a first hidden node becomes visible on the touchscreen display.

In some aspects, the looping structure can comprise a circular or oval shaped element.

In some aspects, the swiping gesture can comprise a touch and swipe on the touchscreen display.

In some aspects, the plurality of nodes can be are arranged on the looping structure such that each node of the plurality of nodes is arranged at a respective position on the looping structure, and wherein a hidden portion of the looping structure is not displayed on the touchscreen display such that the at least one hidden node corresponds to the hidden portion.

In some aspects, the operations can further comprise receiving a second touch input from the user via the touchscreen display. The second touch input can correspond to a selection of the at least one visible node. In response to the second touch input, the method can include transitioning the GUI to display a second looping structure associated with the selected at least one visible node, and a plurality of sub-nodes arranged on the second looping structure. The plurality of sub-nodes can include at least one hidden sub-node and at least one visible sub-node.

In some aspects, transitioning the GUI to display the second looping structure and the plurality of sub-nodes arranged on the second looping structure can comprise zooming into the looping structure.

In some aspects, the method can further comprise receiving a third touch input from the user via the touchscreen display. The third input can correspond to an instruction to redisplay the looping structure. In response to the third touch input, the method can include transitioning the GUI to display the looping structure and the plurality of nodes arranged on the looping structure.

In some aspects, transitioning the GUI to display the looping structure and the plurality of nodes arranged on the looping structure can comprise zooming out of the second looping structure.

In some aspects, the operations can further comprise, in response to the touch input, automatically relocating at least one of the plurality of nodes such that a first visible node becomes hidden or otherwise not shown on the touchscreen display.

In some aspects, the operations can further comprise receiving a pinning input from the user. The pinning input can be associated with a particular visible node and can correspond to an instruction to pin the particular visible node to be displayed on the looping structure such that the particular visible node is consistently displayed in the GUI until being unpinned.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system including an example computing device and an example server computing device according to some implementations of the present disclosure;

FIG. 2 is a functional block diagram of the example computing device of FIG. 1;

FIG. 3 is an example graphical user interface corresponding according to some implementations of the present disclosure;

FIG. 4 is an illustration of various example graphical user interfaces corresponding according to some implementations of the present disclosure;

FIG. 5 is another example graphical user interface corresponding according to some implementations of the present disclosure; and

FIGS. 6A-E are illustrations of an example transition for an example graphical user interface corresponding according to some implementations of the present disclosure.

### DETAILED DESCRIPTION

As previously discussed, a user of a computing device (a mobile phones, a laptop computer, a smart speaker or other smart device, a desktop computer, and the like) may interact with that computing device in many ways. For computing devices that include displays, information may be presented to the user and the user may interact with the displayed information to perform various tasks. For example only, a user may click on, touch, or otherwise select a graphical icon to initiate an action. Such graphical icons may be arranged on the display in various ways, such as in lists or in other patterns. In some instances, multiple icons can be grouped together such that the individual icons become visible only upon selecting the group. While this type of arrangement may be familiar to a user, it is quite utilitarian and may not be the most efficient and/or elegant manner to display the information or permit interaction by the user. Accordingly, the present disclosure is directed to a loop or circular user interface that addresses the above noted and other issues/deficiencies associated with the typical user interface. Further details are included below.

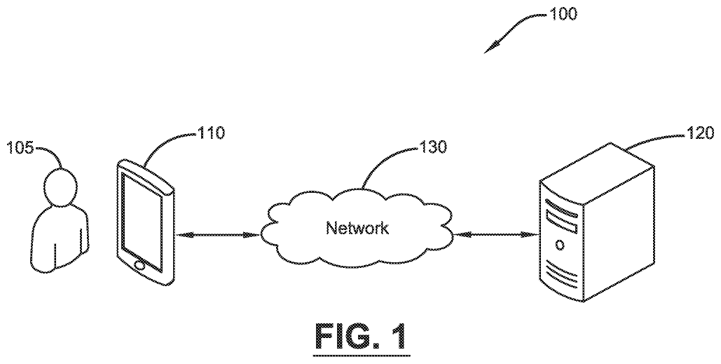

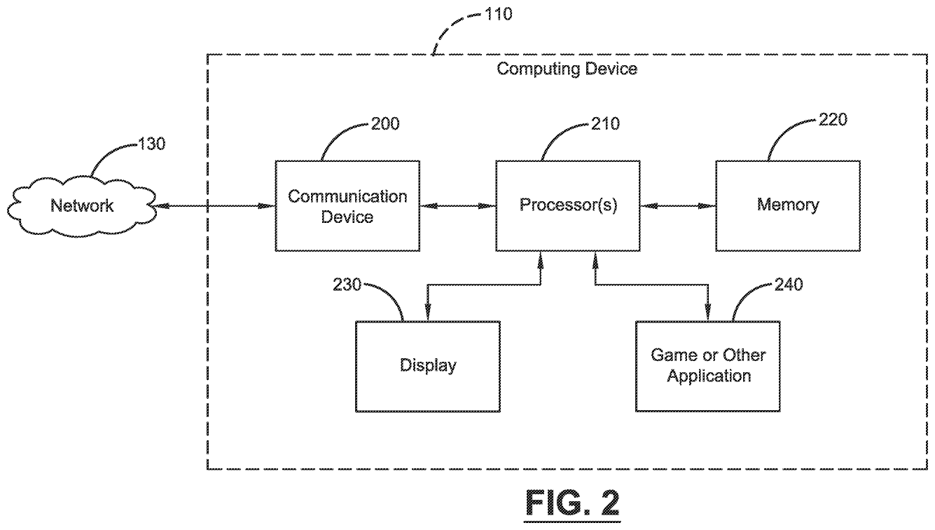

Referring now to FIG. 1, a diagram of an example computing system 100 is illustrated. The computing system 100 can be configured to implement an application that utilizes the graphical user interface (GUI) described herein. The computing system 100 can include one or more example computing devices 110 and one or more example servers 120 that communicate via a network 130 according to some implementations of the present disclosure. For ease of description, in this application and as shown in FIG. 1, one example computing device 110 and one example server computing device 120 are illustrated and described. It should be appreciated, however, that there can be more computing devices 110 and more server computing devices 120 than is illustrated. While illustrated as a mobile phone (“smart” phones), each computing device 110 can be any type of suitable computing device, such as a desktop computer, a tablet computer, a laptop computer, a wearable computing device such as eyewear, a watch or other piece of jewelry, or clothing that incorporates a computing device. A functional block diagram of an example computing device 110 is illustrated in FIG. 2.

The computing device 110 can include a communication device 200, one more processors 210, a memory 220, a display device 230, and a note storage application 240 (referred to herein as “note application 240”). The processor(s) 210 can control operation of the computing device 110, including implementing at least a portion of the techniques of the present disclosure. The term “processor” as used herein is intended to refer to both a single processor and multiple processors operating together, e.g., in a parallel or distributed architecture.

The communication device 200 can be configured for communication with other devices (e.g., the server computing devices 120 or other computing devices 110) via the network 130. One non-limiting example of the communication device 200 is a transceiver, although other forms of hardware are within the scope of the present disclosure. The memory 220 can be any suitable storage medium (flash, hard disk, etc.) configured to store information. For example, the memory 220 may store a set of instructions that are executable by the processor 210, which cause the computing device 110 to perform operations, e.g., such as the operations of the present disclosure. The display device 230 can display information to the user 105. In some implementations, the display device 230 can comprise a touch-sensitive display device (such as a capacitive touchscreen and the like), although non-touch display devices are within the scope of the present disclosure.

It should be appreciated that the example server computing devices 120 can include the same or similar components as the computing device 110, and thus can be configured to perform some or all of the techniques of the present disclosure, which are described more fully below. Further, while the techniques of the present disclosure are described herein in the context of a computing device 110, it is specifically contemplated that each feature of the techniques may be performed by a computing device 110 alone, a plurality of computing devices 110 operating together, a server computing device 120 alone, a plurality of server computing devices 120 operating together, and a combination of one or more computing devices 110 and one or more server computing devices 120 operating together.

A game or other application 240 (referred to herein as the “game application 240”) can allow a user 105 to interact with her/his computing device 110 and, in some situations, other users. The game application 240 can be password protected such that only a certain user 105 may access the game application and any associated data. The game application 240 can store information locally at the computing device 110 (e.g., in memory 220) and/or remotely from the computing device 110 (e.g., on a cloud based server such as server computing devices 120 or an external database). In some embodiments, the user can access information by clicking an icon or link presented on the display 230 by the game application 240. Various example embodiments are described more fully below.

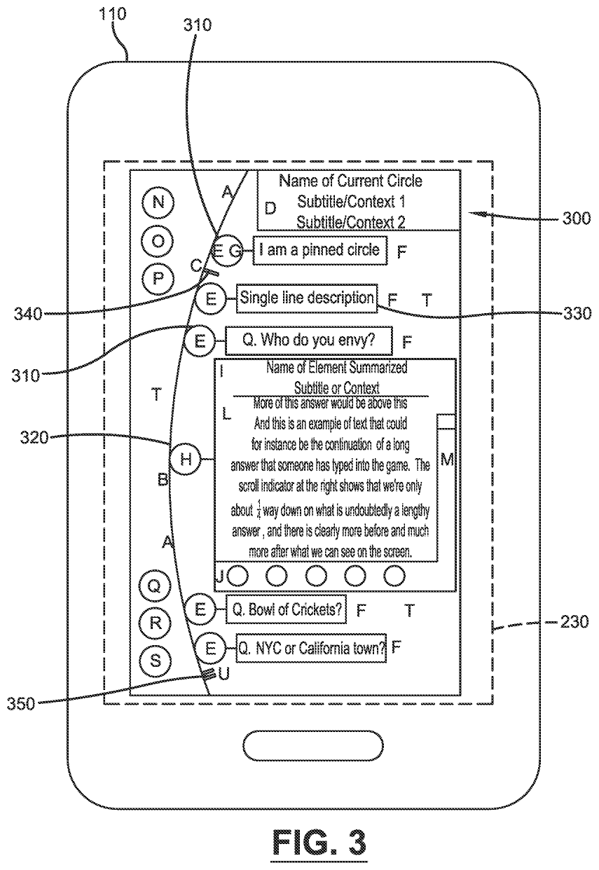

With reference to FIG. 3, an example graphical user interface 300 corresponding to a game application 240 according to some implementations of the present disclosure is shown. In this example, the display 230 displays a portion of the graphical user interface 300. The graphical user interface (“GUI”) 300 includes a plurality of nodes 310 arranged on the outside of a circular element 320. Each of the nodes 310 can be a circle, square, or other shape arranged on the periphery of the displayed circular element 320. Further, the circular element 320 can be any form of looping structure on which the nodes 310 are arranged and that can be “rotated” by the user to bring nodes 310 into and out of view, as further described below. Example looping structures include, but are not limited to, circles, ovals, arcs (closed or open), and open ended curves. For ease of description, the term “circular element 320” will be used herein to encompass all such looping structures. In some implementations, and as illustrated in FIG. 3, only a portion of the circular element 320 (and its associated nodes 310) will be displayed on the display 230 of the computing device 110 at one time. The user may interact with the GUI 300 to rotate the circular element 320 and bring the previously “hidden” nodes 310 into the displayed area. Each node in the displayed area can also include a text box 330 or similar item that provides a description of the node 310, such as a title, a topic description, a group name, or the like.

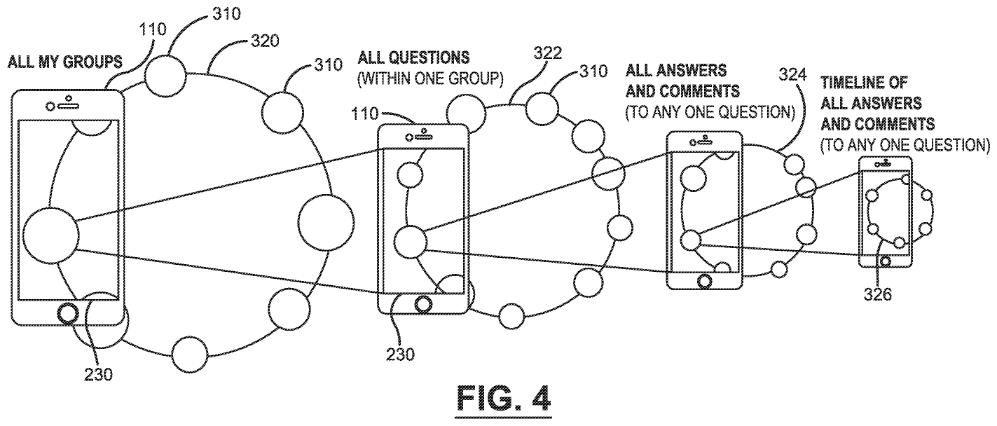

In some implementations, and with additional reference to FIG. 4, the user may select a node 310 to access the selected node and bring a new sub-circle 322 associated with that node 310 into view (in a sub-circle 322 embedded within a circle 320 arrangement). As illustrated in FIG. 4, any node 310 may include an embedded sub-circle (sub-circle 322, sub-sub-circle 324, sub-sub-sub-circle 326, etc.) that can be accessed via selection of a node 310. Each sub-circle 322, 324, 326 can have the same or similar structure, elements, etc. of the circle 320, and can be interacted with in the same/similar manner.

Referring again to FIG. 3, a user may “pin” (via selection, double click, or any other interaction) a node 310 to be consistently displayed in the GUI 300 on the display 230. In some aspects, a pin indicator 340 may be included on the circle 320 to differentiate pinned nodes 310 from other nodes 310. For example only, the nodes 310 above the pin indicator 340 can be consistently displayed in the GUI 300 and do not rotate as the circle 320 is rotated by the user. It should be appreciated that other forms of pin indicators 340 could be utilized with the GUI 300. Additionally or alternatively, the GUI 300 can include a rotation indicator 350 that signals a specific location on the circle 320 such that the user will be aware of a full rotation of the circle 320.

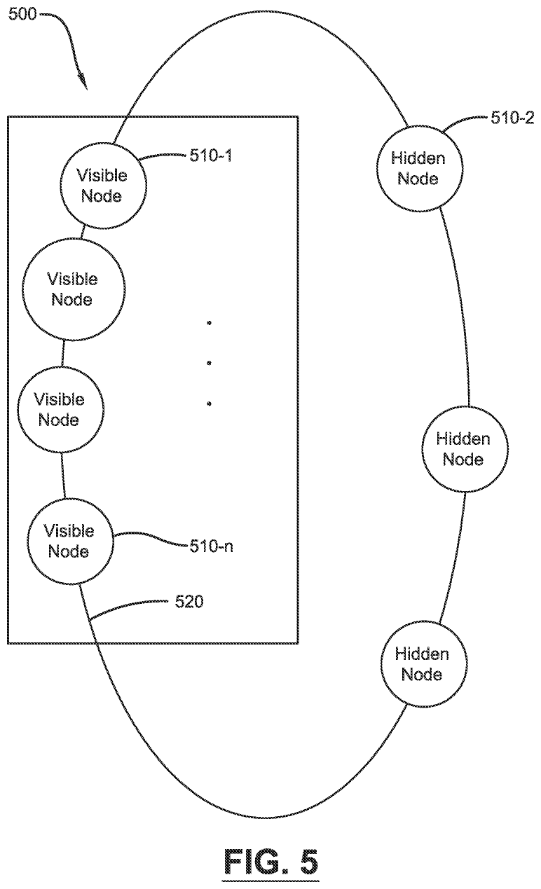

With additional reference to FIG. 5, another example graphical user interface (“GUI”) 500 corresponding to a game application 240 according to some implementations of the present disclosure is shown. Similar to the GUI 300, the GUI 500 includes a plurality of nodes 510-1, 510-2, . . . 510-n (referred to herein both collectively and individually as “node(s) 510”) arranged on the outside of a looping structure 520. Each of the nodes 510 can be a circle, square, or other shape arranged on the periphery of the displayed looping structure 520. In some implementations, and as illustrated in FIG. 5, only a portion of the looping structure 520 (and its associated nodes 510) will be displayed on the display 230 of the computing device 110 at one time. For example only, the nodes 510 can include at least one visible node 510-1 that is shown on the display and at least one hidden node 510-2 that is not displayed. In FIG. 5, the hidden node 510-2 is shown as being outside the area of the display 230.

The user can provide a touch input such that the looping structure 520 can be “rotated” by the user to bring various nodes 510 into and out of view. In some implementations, the touch input can comprise a touch and a swipe on the touchscreen display 230 that virtually “grabs” and “spins/rotates” the looping structure 520. In this manner, the user can interact with the GUI 500 to rotate the circular element 520 and relocate the previously “hidden” nodes 510 into the displayed area and/or relocate the previously displayed nodes 510 out of the display area. For example only, each of the nodes 510 can be arranged (pinned, fixed, etc.) to a specific respective position on the looping structure 520. Rotation of the looping structure 520 can automatically relocate the nodes 510 to a position that is or is not displayed on the display 230. In this manner, rotation of the looping structure 520 can result in automatically relocating at least one visible node 510-1 such that it is hidden or otherwise not shown (in a hidden, not displayed, portion of the looping structure 520) and/or in automatically relocating at least one hidden node 510-2 to become visible on the display 230 (in a visible portion of the looping structure 520).

The GUI 500 can be utilized as a convenient and intuitive way of organizing and displaying information in a hierarchical manner. The GUI 500 can display a looping structure 520 and a plurality of nodes 510 at various levels, wherein each of the plurality of nodes 510 can be selected to display a different, sub-level of nodes 510 (sub-node) arranged on an additional looping structure 520. As briefly mentioned above in reference to FIG. 4, a user may interact with the GUI 500 to select a node 510 to access the selected node 510 to display its looping structure 520 and corresponding sub-node(s) 522. As illustrated in FIG. 4, any node 310 may include an embedded sub-circle (sub-circle 322, sub-sub-circle 324, sub-sub-sub-circle 326, etc.) that can be accessed via selection of a node 310. GUI 500 can be similarly arranged and constructed. A user can interact with the GUI 500 (via the touchscreen display 230) to zoom into and/or zoom out from the presently displayed looping structure 520 to navigate through the levels of looping structures 520 and associated (sub-)nodes 510.

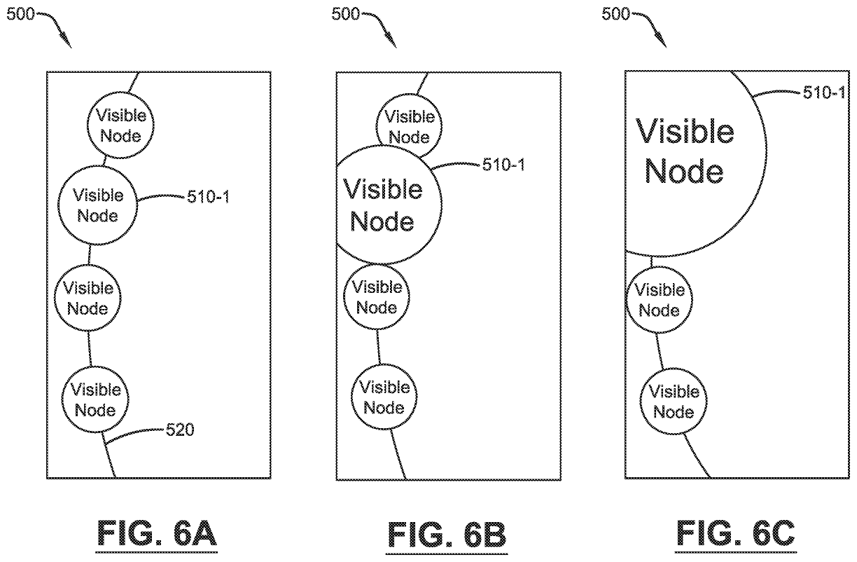

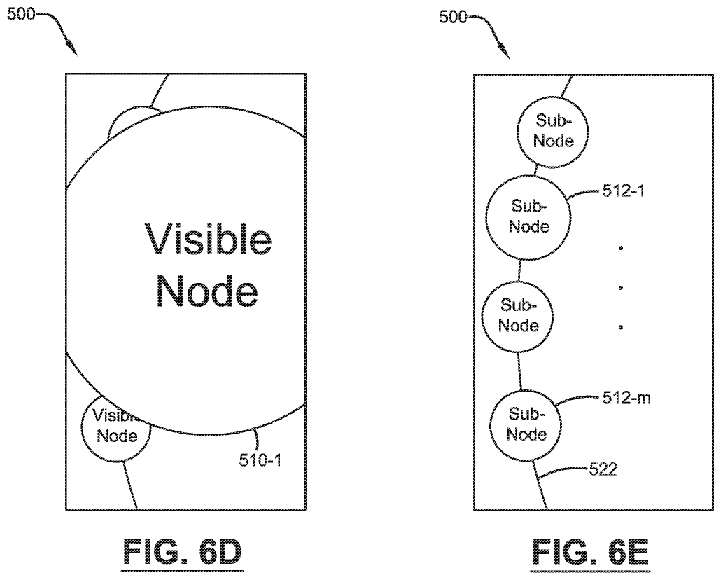

An example of the navigation through various levels in the GUI 500 is shown in FIGS. 6A-6E. A user can provide a touch input via the touchscreen display 230 that corresponds to a selection of a particular visible node 510-1. In response to the touch input, the GUI 500 can be transitioned to display a looping structure (a second looping structure) 522 associated with the particular visible node 510-1. A plurality of sub-nodes 512-1, 512-2, . . . 512-m (referred to herein both collectively and individually as “sub-node(s) 512”) can be arranged on the second looping structure 522, where the plurality of sub-nodes 512 include at least one hidden sub-node (not shown) and/or at least one visible sub-node 512-1. As shown in the sequence of FIGS. 6A-E, transitioning the GUI 500 to display the second looping structure 522 can comprise zooming into the looping structure 520 and/or the at least one visible node 510-1 that was selected. In this manner, the GUI 500 can provide an animation that is illustrative of the hierarchical structure of the GUI 500 and the information (nodes, sub-nodes, sub-sub-nodes, etc.) presented therein.

Similar to the zooming into animation described above, a zooming out animation can be initiated upon the user can providing a touch input via the touchscreen display 230. In the illustrated example of FIGS. 6A-E, the touch input can be received via the GUI of FIG. 6E and can correspond to an instruction to redisplay the looping structure 520 of FIG. 6E. In response to this touch input, the GUI 500 can be transitioned to display the looping structure 520 and the plurality of nodes 510 arranged thereon. As shown in the sequence of FIGS. 6E-A (reverse order), transitioning the GUI 500 to display the looping structure 520 can comprise zooming out of the looping structure 522 and/or the visible node(s) 512 arranged thereon. In this manner, once again the GUI 500 can provide an animation that is illustrative of the hierarchical structure of the GUI 500 and the information (nodes, sub-nodes, sub-sub-nodes, etc.) presented therein.

Various forms of touch input can be received from the user. In some implementations, a simple touch/press corresponding to a selection of a particular node 510 can be utilized to trigger the zooming in animation. In other aspects, a simple touch/press corresponding to a selection of a particular node 510 can be utilized to trigger a further display of information associated with the selected node 510, and a different type of touch input (a long press, a double tap, etc.) can trigger the zooming in animation. In some aspects, a two finger touch input (a pinch or spread) can be utilized to trigger a zoom animation (zoom out or zoom in, respectively). Additionally or alternatively, a button or icon can be displayed in the GUI 500 to initiate the switching between levels of the looping structures 520, 522.

As briefly mentioned above in regards FIG. 3 and the pinning of a node 310, a node 310, 510 can be consistently displayed in the GUI 300, 500 on the display 230 by the user providing a pinning input via the GUI 300, 500. The pinning input is associated with one or more nodes 310, 510 (such as visible node 510-1) and can correspond to an instruction to pin the associated node 510-1 such that it is consistently displayed in the GUI 300, 500 until being unpinned. In some aspects, a pin indicator 340 may be included in the GUI 300, 500 to differentiate pinned nodes 310 from other nodes 310. For example only, the nodes 310 above the pin indicator 340 can be consistently displayed in the GUI 300 and do not rotate as the looping structure 320, 520 is rotated by the user. It should be appreciated that other forms of pin indicators 340 could be utilized with the GUI 300.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for interacting with a computing device, comprising:
displaying, on a touchscreen display of a computing device having one or more processors, a graphical user interface (“GUI”), wherein the GUI includes:
a looping structure, and
a plurality of nodes arranged on the looping structure, wherein the plurality of nodes includes at least one hidden node and at least one visible node;
receiving, at the computing device, a touch input from a user via the touchscreen display, the touch input comprising a swiping gesture; and
in response to the touch input:
rotating the looping structure, and
automatically relocating at least one of the plurality of nodes such that a first hidden node becomes visible on the touchscreen display.

2. The computer-implemented method of claim 1, wherein the looping structure comprises a circular or oval shaped element.

3. The computer-implemented method of claim 1, wherein the swiping gesture comprises a touch and swipe on the touchscreen display.

4. The computer-implemented method of claim 1, wherein the plurality of nodes are arranged on the looping structure such that each node of the plurality of nodes is arranged at a respective position on the looping structure, and wherein a hidden portion of the looping structure is not displayed on the touchscreen display such that the at least one hidden node corresponds to the hidden portion.

5. The computer-implemented method of claim 1, further comprising:
receiving, at the computing device, a second touch input from the user via the touchscreen display, the second touch input corresponding to a selection of the at least one visible node; and
in response to the second touch input, transitioning the GUI to display:
a second looping structure associated with the selected at least one visible node, and
a plurality of sub-nodes arranged on the second looping structure, wherein the plurality of sub-nodes includes at least one hidden sub-node and at least one visible sub-node.

6. The computer-implemented method of claim 5, wherein transitioning the GUI to display the second looping structure and the plurality of sub-nodes arranged on the second looping structure comprises zooming into the looping structure.

7. The computer-implemented method of claim 5, further comprising:
receiving, at the computing device, a third touch input from the user via the touchscreen display, the third input corresponding to an instruction to redisplay the looping structure; and
in response to the third touch input, transitioning the GUI to display the looping structure and the plurality of nodes arranged on the looping structure.

8. The computer-implemented method of claim 7, wherein transitioning the GUI to display the looping structure and the plurality of nodes arranged on the looping structure comprises zooming out of the second looping structure.

9. The computer-implemented method of claim 1, further comprising, in response to the touch input, automatically relocating at least one of the plurality of nodes such that a first visible node becomes hidden or otherwise not shown on the touchscreen display.

10. The computer-implemented method of claim 1, further comprising:
receiving, at the computing device, a pinning input from the user, the pinning input being associated with a particular visible node and corresponding to an instruction to pin the particular visible node to be displayed on the looping structure such that the particular visible node is consistently displayed in the GUI until being unpinned.

11. A computing device, comprising
one or more processors;
a touchscreen display operably connected to the one or more processors; and
a non-transitory computer-readable storage medium having a plurality of instructions stored thereon, which, when executed by the one or more processors, cause the one or more processors to perform operations comprising:
displaying, on the touchscreen display, a graphical user interface (“GUI”), wherein the GUI includes:
a looping structure, and
a plurality of nodes arranged on the looping structure, wherein the plurality of nodes includes at least one hidden node and at least one visible node;
receiving a touch input from a user via the touchscreen display, the touch input comprising a swiping gesture; and
in response to the touch input:
rotating the looping structure, and
automatically relocating at least one of the plurality of nodes such that a first hidden node becomes visible on the touchscreen display.

12. The computing device of claim 11, wherein the looping structure comprises a circular or oval shaped element.

13. The computing device of claim 11, wherein the swiping gesture comprises a touch and swipe on the touchscreen display.

14. The computing device of claim 11, wherein the plurality of nodes are arranged on the looping structure such that each node of the plurality of nodes is arranged at a respective position on the looping structure, and wherein a hidden portion of the looping structure is not displayed on the touchscreen display such that the at least one hidden node corresponds to the hidden portion.

15. The computing device of claim 11, wherein the operations further comprise:
receiving a second touch input from the user via the touchscreen display, the second touch input corresponding to a selection of the at least one visible node; and
in response to the second touch input, transitioning the GUI to display:
a second looping structure associated with the selected at least one visible node, and
a plurality of sub-nodes arranged on the second looping structure, wherein the plurality of sub-nodes includes at least one hidden sub-node and at least one visible sub-node.

16. The computing device of claim 15, wherein transitioning the GUI to display the second looping structure and the plurality of sub-nodes arranged on the second looping structure comprises zooming into the looping structure.

17. The computing device of claim 15, wherein the operations further comprise:
Receiving a third touch input from the user via the touchscreen display, the third input corresponding to an instruction to redisplay the looping structure; and
in response to the third touch input, transitioning the GUI to display the looping structure and the plurality of nodes arranged on the looping structure.

18. The computing device of claim 17, wherein transitioning the GUI to display the looping structure and the plurality of nodes arranged on the looping structure comprises zooming out of the second looping structure.

19. The computing device of claim 11, wherein the operations further comprise, in response to the touch input, automatically relocating at least one of the plurality of nodes such that a first visible node becomes hidden or otherwise not shown on the touchscreen display.

20. The computing device of claim 11, wherein the operations further comprise:
receiving a pinning input from the user, the pinning input being associated with a particular visible node and corresponding to an instruction to pin the particular visible node to be displayed on the looping structure such that the particular visible node is consistently displayed in the GUI until being unpinned.
